(19) United States
(12) Patent Application Publication
(10) Pub. No.: US 2011/0267418 A1
(43) Pub. Date: Nov. 3, 2011

(54) TELEMEDICINE SYSTEM

(76) Inventors: Alejandro Javier Patron Galindo, D.F. Mexico (MX); Carlos G. Iglesias Ramos, D.F. Mexico (MX)

(21) Appl. No.: 13/097,438

(22) Filed: Apr. 29, 2011

Related U.S. Application Data
(60) Provisional application No. 61/329,778, filed on Apr. 30, 2010.

(51) Int. Cl. H04N 7/15

(52) U.S. Cl. 348/14.04; 348/E07.083

(57) ABSTRACT

A telemedicine device and system for audio/video communication and real time interfacing with peripheral biomedical devices accessible by individuals in different locations.

This application claims priority to provisional application No. 61/329,778, filed Apr. 30, 2010, which is incorporated by reference herein.

### FIELD OF THE INVENTION

The present invention relates to telemedicine systems which enable health services to be provided at a distance by monitoring the condition of patients remotely. More specifically, the invention relates to telemedicine systems which monitor the condition of patients with several peripheral biomedical devices at the same time and provide long-distance video consultation.

### BACKGROUND OF THE INVENTION

In the field of telemedicine systems, the following patents are relevant:

U.S. Pat. No. 7,185,282, issued to Naidoo, et al. on Feb. 27, 2007, entitled: “Interface device for an integrated television-based broadband home health system.”

U.S. Pat. No. 7,835,926, issued to Naidoo, et al. on Nov. 14, 2010, entitled: “Method for conducting a home health session using an integrated television-based broadband home health system.”

U.S. Pat. No. 7,454,359, issued to Rosenfeld, et al. on Nov. 18, 2008, entitled: “System and method for displaying a health status of hospitalized patients.”

U.S. Pat. No. 7,307,543, issued to Rosenfeld, et al. on Dec. 11, 2007, entitled: “System and method for video observation of a patient in a health care location.”

U.S. Pat. No. 7,912,733, issued to Clements, et al. on Mar. 22, 2011, entitled: “System, method and program product for delivering medical services from a remote location.”

U.S. Pat. No. 7,860,725, issued to Gopinathan, et al. on Dec. 28, 2010, entitled: “Method for remote medical consultation and care.”

Telemedicine systems and methods for monitoring and interacting with a primary user are known. The more common telemedicine systems suffer from disadvantages because they are only focused on one area and cannot be attached to several medical instruments. For those instruments where information on the condition of the patient is being monitored by different devices, the primary user is typically in constant communication with patients at a certain location. Typical disadvantages of these devices are that they can only monitor certain parameters and only patients at that location.

### SUMMARY OF THE INVENTION

The term “telemedicine,” as used herein refers to a wide field of applications and systems designed for long-distance video consultation and/or monitoring of patients, i.e., long distance medicine.

The telemedicine system of his invention provides videoconferencing (consultation) and can monitor the condition of patients with several peripheral biomedical devices at the same time, which is easily operated through control software which preferably provides an iconographic interface. The control software, through a computer, issues commands to an audio/video matrix switch, a videoconference CODEC and optionally the different peripheral biomedical devices attached to or otherwise in communication with the system, while the computer is receiving and processing information (data) and, according to this information (data), executing different actions.

The telemedicine system of this invention can provide interaction with multiple peripheral biomedical devices that allow the conduction of long-distance and/or local medical consultation, preferably by means of iconographic control software. The patient can be provided with clinical care through videoconference and, at the same time, the telemedicine system of this invention displays and controls the patient's information that is transmitted, either in video, audio or as data. This information is obtained from multiple and different peripheral biomedical devices that each have video, audio and/or data standards. Each of these peripheral biomedical devices interacts with the telemedicine system of this invention.

The following are definitions for some terms used in the specification and in the art.

Shared environment—Refers to the common space shared by several monitors simultaneously receiving the same signal from a CPU. This makes it possible to navigate among them within the same signal as if only one monitor was involved. The screens are configured in such a way that they share the same space occupied by the desktop screen. This makes it possible to move the cursor around the screens using one mouse.

DICOM Standard—DICOM (“Digital Imaging and Communication in Medicine”) is the standard communication protocol for the exchange, management, storage, printing and transmission of information in medical imaging. It includes a file format definition and a network communications protocol. The communication protocol is an application protocol that uses TCP/IP to communicate between systems.

Iconographic Control Software—Is software used to control electronic devices such as a computer of the telemedicine systems of this invention, with a graphical user interface that uses icons (a small pictogram) to communicate information to the user.

“In communication with”—refers to the ability to transfer data either by physical attachment, such as an electrical connection or by the transmission and reception of several wireless technologies such as Bluetooth WiFi, ZigBee, etc. without a physical attachment.

Medical image viewer—Application for managing, visualizing, transmitting and interpreting DICOM-standard medical degree imaging.

Peripheral biomedical equipment—Medical equipment that is connected to or otherwise in communication with the computer of the telemedicine system of this invention. The peripheral biomedical equipment can vary widely and typically monitors the condition of a patient. As peripheral devices they are not part of the computer but they can form part of a telemedicine system for some embodiments of this invention. Theses embodiments are not limited to any particular peripheral biomedical equipment. Any commercially available peripheral biomedical equipment can be used.

Video-consultation—The distance consultation made with the interaction of the end users (attending physician caring for a patient and medical specialist) of the workstations linked together.

The telemedicine system of this invention is able to establish a real-time or time-delayed audio, video and data bidirectional communication with other compatible equipment preferably with ITU-T H.323, H.320 and SIP standards for real-time communication (e.g., videoconference) and DICOM or FTP standards for time-delayed communication, also known as “store an forward” communication.

The computer, conducted by the control software, issues commands at the audio/video matrix switch, the videoconference CODEC and optionally the different peripheral biomedical devices attached to or otherwise in communication with the system, while the computer is receiving and processing information (data), and depending on this information (data), the computer executes different actions. The audio/video matrix switch receives instructions from the control software and sends information regarding its status in order to execute changes in input and output ports. The videoconference CODEC communicates with the control software and executes the corresponding functions to transmit audio and video signals, preferably:

Line Level audio signals;

digital audio signals;

C-video, S-Video, Component (C-video) and RGB 1 analog video signals, and

SDI digital video signals.

Peripheral biomedical devices optionally receive instructions from the computer with control software. Where these peripheral biomedical devices output audio and/or video signals, these signals are sent to the audio/video matrix switch, which controls the display of these audio and/or video signals. Where the peripheral biomedical devices generate output in formats other than audio and/or video signals (data), the output (data) is sent directly to the computer to be processed. The control software directly controls the display of this output (data).

The invention comprises various embodiments of a telemedicine system including, for example:
A. a computer with control software preferably capable of providing an icon-o-graphic interface on a video screen;
B. a high definition (HD) videoconference CODEC, preferably compatible with ITUT H.320 H.323 and SIP standards, in communication with the computer and controlled by the control software;
C. at least two inputs for peripheral biomedical devices to provide communication with the computer, and optionally, the peripheral biomedical devices in communication with said computer through said inputs;
D. and an audio/video matrix switch in communication with the computer and controlled by the control software, said audio/video matrix switch capable of
   1) controlling video/audio inputs and outputs, preferably through at least one of RS-232 or Ethernet interfaces,
   2) transmitting audio signals to at least one speaker
   3) transmitting video signals to at least one video screen and
   4) integrating and controlling the communication of the various peripheral biomedical devices with the computer.

In another embodiment of the telemedicine system of this invention, the communication of one or more of peripheral biomedical devices with the computer is directly controlled by the control software. In a subset of these embodiments, the control software allows the execution and configuration of software applications required by the peripheral biomedical devices to function properly.

The above telemedicine systems may optionally use icon-o-graphic control software to control the audio/video display of said bidirectional communication and control the audio/video display of said peripheral biomedical devices.

In certain embodiments, the control software measures broadband traffic and reconfigures the speed of the video-consultation automatically.

The peripheral biomedical devices in communication with the computer optionally include but are not limited to any of the following: electronic stethoscope, dermatoscope, X-Ray Scanner, or electrocardiograph.

In another embodiment of this invention, a telemedicine system is provided which is capable of being used for integrating multiple medical instruments and capable of transmitting and receiving medical instrument data and real-time or time delayed audio/video data to and from a corresponding telemedicine system and is made up of, for example, the following:
A. a portable frame for supporting electronic equipment;
B. electronic equipment, including a computer for processing data and audio/video signals, supported by said portable frame;
C. at least two inputs for medical instruments for providing input (data, video or audio) to said electronic equipment, and optionally, the medical instruments in communication with said electronic equipment through said inputs;
D. camera and microphone for providing audio/video input (signals) to said electronic equipment;
E. at least two video screens, preferably touch screen enabled, and at least one speaker for providing audio/video output from said electronic equipment;
F. preferably a mouse and keyboard for providing user input to said electronic equipment;
G. and control software stored in said computer which can
display inputs from said medical instruments, microphone, and camera, in the form of descriptive icons,
share input data with at least one other corresponding telemedicine system in a different location, and
allow the user of the telemedicine system or the user of a corresponding telemedicine system to control the display of inputs from said medical instruments, microphone, and camera on multiple video screens through the manipulation of said descriptive icons by touching the video screens or by use of the mouse or keyboard.

In a preferred embodiment, the control software provides:
i. movable descriptive icons representing each of the medical instruments inputs and the camera and microphone inputs from each telemedicine system;
ii. identifiable locations where moveable descriptive icons can be moved to on a video screen to activate audio/video output that corresponds to the input the icon represents; and
iii. non-movable icons that allow the user to control the audio/visual display.

In some specific embodiments, there are exactly two video screens used in the telemedicine system.

In some specific embodiments, the telemedicine system has at least four inputs for medical instruments to provide input (data, video or audio) to said electronic equipment. Optionally, the telemedicine system includes the medical instruments in communication with said electronic equipment through said inputs.

In some specific embodiments, the non-movable icons control only video zoom function and the audio volume control.

In some specific embodiments, the software stores data from the medical instruments, camera, and microphone on a network or on the hard drive of the computer and associates the data with an icon that appears on the user interface screen. In certain embodiments, image data is converted to DICOM format and then stored.

In a distinct embodiment of the invention, the telemedicine system has all features and elements set forth above but the telemedicine system cannot receive medical instrument data. Examples of these embodiments include telemedicine systems without inputs for medical instruments to provide data, video or audio to said electronic equipment and telemedicine systems where there are no medical instruments in communication with the electronic equipment through the inputs available.

In another distinct embodiment of the invention, the telemedicine system has all of the features and elements set forth above but only one medical device provides input data to said electronic equipment. Examples of these embodiments include telemedicine systems with only one input for medical instruments to provide data, video or audio to said electronic equipment and telemedicine systems where there is only one medical instrument in communication with the electronic equipment through the inputs available.

In further embodiment of the invention, a telemedicine system capable of being networked with at least one other telemedicine system is provided. This telemedicine system is capable of receiving and displaying medical instrument, microphone, and camera audio/video input data from a corresponding telemedicine system in real time but only transmits microphone, and camera audio/video inputs in real time or time delayed to a corresponding telemedicine system. This telemedicine system comprises, for example:
A. a portable frame for supporting electronic equipment;
B. electronic equipment, including a computer, for processing data and audio/video signals, supported by said portable frame;
C. camera and microphone for providing audio/video input (signals) to said electronic equipment;
D. at least two video screens, preferably touch screen enabled, and at least one speaker for providing audio/video output from said electronic equipment;
E. preferably, a mouse and keyboard for providing user input to said electronic equipment;
F. and control software stored in said computer which can
display inputs from medical instruments and said microphone and camera, in the form of descriptive icons,
share input data with at least one other corresponding telemedicine system in a different location, and
allow the user of the telemedicine system or the user of a corresponding telemedicine system to control the display of inputs from medical instruments and said microphone and camera on multiple video screens through the manipulation of said descriptive icons by touching the video screens or by use of the mouse or keyboard.

In a preferred embodiment, the control software provides:
i. movable descriptive icons representing each of the medical instruments inputs and the camera and microphone inputs from each telemedicine system;
ii. identifiable locations where moveable descriptive icons can be moved to on a video screen to activate audio/video output that corresponds to the input the icon represents; and
iii. non-movable icons that allow the user to control the audio/visual display.

In some specific embodiments, the telemedicine system receiving the informational data has more video display screens than a telemedicine system that is transmitting the data from the medical instruments, microphone, and camera audio/video inputs.

In some specific embodiments, the telemedicine system has four video display screens.

In some specific embodiments, the telemedicine system additionally has at least four inputs for medical instruments to provide input (data, video or audio) to said electronic equipment. Optionally, the telemedicine system includes the medical instruments in communication with said electronic equipment through said inputs.

In some specific embodiments, the non-movable icons control only video zoom function and the audio volume control.

In some specific embodiments, the software stores data from the medical instruments, camera, and microphone on a network or on the hard drive of the computer and associates the data with an icon that appears on a user interface screen.

In a distinct embodiment of the invention, the telemedicine system has all of the features and elements set forth above but only one medical device provides input data to said electronic equipment. Examples of this embodiment include telemedicine systems with only one input for medical instruments to provide data, video or audio to said electronic equipment and telemedicine systems where there is only one medical instrument in communication with the electronic equipment through the inputs available.

Another embodiment of the invention is a network of telemedicine systems comprising at least two independent telemedicine systems that can provide video/audio communication and information from medical instruments at a remote location to at least one other location in real time or time delayed, said network comprising for example:
A. At least one telemedicine system for integrating multiple medical instruments and capable of transmitting and receiving medical instrument data and real-time audio/video data to and from a corresponding telemedicine system comprising for example:
i. a portable frame for supporting electronic equipment;
ii. electronic equipment, including a computer, for processing data and audio/video signals, supported by said portable frame;
iii. at least two inputs for medical instruments for providing input (data, video or audio) to said electronic equipment, and optionally, the medical instrument in communication with said electronic equipment through said inputs;
iv. camera and microphone for providing audio/video input (signals) to said electronic equipment;
v. at least two video screens, preferably touch screen enabled, and at least one speaker for providing audio/video output from said electronic equipment;
vi. preferably a mouse and keyboard for providing user input to said electronic equipment; and
vii. control software stored in said computer which can
   display inputs from said medical instruments, microphone, and camera, in the form of descriptive icons,
   share input data with at least one other corresponding telemedicine system in a different location, and
   allow the user of the device or the user of a corresponding telemedicine system to control the display of inputs from said medical instruments, microphone, and camera on multiple video screens through the manipulation of said descriptive icons by touching the video screens or by use of the mouse or keyboard.
In a preferred embodiment, the control software provides:
   i. movable descriptive icons representing each of the medical instruments inputs and the camera and microphone inputs from each telemedicine system;
   ii. identifiable locations where moveable descriptive icons can be moved to on a video screen to activate audio/video output that corresponds to the input the icon represents; and
   iii. non-movable icons that allow the user to control specific functions of each medical instrument and manipulate said medical instruments audio/visual display, and
B. At least one telemedicine system for receiving and displaying medical instruments, microphone, and camera audio/video input data from a corresponding telemedicine system but only transmits microphone, and camera audio/video inputs in real time or time delayed to a corresponding telemedicine system comprising for example:
i. a portable frame for supporting electronic equipment;
ii. electronic equipment, including a computer for processing data and audio/video signals, supported by said portable frame;
iii. camera and microphone for providing audio/video input (signals) to said electronic equipment;
iv. at least two video screens, preferably touch screen enabled, and at least one speaker for providing audio/video output from said electronic equipment;
v. preferably a mouse and keyboard for providing user input to said electronic equipment; and
vi. control software stored in said computer which can
   display inputs from medical instruments and said microphone and camera, in the form of descriptive icons,
   share input data with at least one other corresponding telemedicine system in a different location, and
   allow the user of the telemedicine system or the user of a corresponding telemedicine system to control the display of inputs from medical instruments and said microphone and camera on multiple video screens through the manipulation of said descriptive icons by touching the video screens or by use of the mouse or keyboard.

In a preferred embodiment, the control software provides:
i. movable descriptive icons representing each of the medical instruments inputs and the camera and microphone inputs from each telemedicine system;
ii. identifiable locations where moveable descriptive icons can be moved to on a video screen to activate audio/video output that corresponds to the input the icon represents; and
iii. non-movable icons that allow the user to control specific functions of each medical instrument and manipulate said medical instruments audio/visual display.

In some specific embodiments, the telemedicine system capable of transmitting medical instrument data has fewer video screens than the telemedicine system only capable of receiving medical instrument data.

In some specific embodiments, the telemedicine system capable of transmitting medical instrument data has 2 video screens and the telemedicine system only capable of receiving medical instrument data has 4 video screens. More specific embodiments, the telemedicine systems include a remote video annotation option which will allow video to be displayed, such as to a patient, annotated remotely, such as by a physician.

In some specific embodiments, the telemedicine system capable of transmitting medical instrument data are not capable of receiving medical instrument data.

In some specific embodiments, the software stores data from the medical instruments, camera, and microphone on a network or on the hard drive of the telemedicine system and associates the data with an icon that appears on the user interface screen of any telemedicine systems in the system and is accessed when the icon is moved to a location representing a video screen on the telemedicine system.

In some specific embodiments, accessing an icon displays the data from the medical instrument, camera, and/or microphone associated with it in real time.

In some specific embodiments, a camera, speakers and microphone devices are associated with the telemedicine system.

In some specific embodiments, accessing an icon associated with the camera and microphone displays the data from the camera and microphone in real time, but accessing and icon associated with a medical instrument displays the data from the medical instrument with a time delay.

In some specific embodiments, the input data displayed can be paused, fast forwarded, or rewound.

In some specific embodiments, the telemedicine system produces and displays data at least at the DICOM Standard.

The screens in the two monitor embodiments preferably are configured in such a way that they share the same space occupied by the desktop screen. This makes it possible to move the cursor around the screens using the mouse. The windows available may also be dragged as described and moved from one monitor to the other and vice versa. Certain programs may be optionally limited to only one monitor. In another embodiment of the invention, the monitors are capable of displaying medical quality images, video, and audio.

The screens in the four monitor embodiments are configured in such a way that they share the same space occupied by the desktop which works as only one screen through said four monitors. This makes it possible to move the cursor around the screens using the mouse. The windows may be dragged in the same way and moved from one monitor to another and vice versa. Certain programs may be optionally limited to only one monitor.

Users interface with the system in various ways. For example, creating or selecting a user profile, which can optionally be provided by a Local System Administrator.

As a user logs into the system, the system display is represented in part by a permanent board or screen that will be displayed. This board or screen is divided into three parts: the Control Panel Local Folder, Connection Button, and Control Panel Remote Folder. The Control Panel Local Folder shows the same distinctive components as the Control Panel Remote Folder, but the local folder show what information is shown on the local displays and the remote folder shows what is being shown on the remote displays. The connection button indicates whether a connection to a corresponding remote system has been established. Colors may optionally be used to represent the status of a device, for example, if the device is on, it may optionally be highlighted in green whereas if the device is off or inactive it may optionally be highlighted in red. A description and function of the some control panel local folder tab icons can be found in FIG. 7.

Also on the display are input device buttons or icons optionally represented on a task bar which represents inputs, such as peripheral biomedical devices, into the system. Other icons may also be present such as recording tool icons and printing icons. Each icon acts as a way to perform specific task in the system such as recording audio or video of one of the peripheral devices or printing. For the description and functions of some input-device bar icons, see FIG. 8.

When used in video conferencing, the display may optionally show an interface tool for interacting with various tools useful for manipulating the display such as volume control, zooming in and out with the camera, a picture in picture toggle switch, and an on and off switch. The description and function of some optional camera control buttons can be seen in FIG. 9.

In some embodiments, at least one of video, audio, or images are displayed and are controlled through the use of the icon-o-graphic control system. For examples of audio and video control tool icons, please see FIG. 10. The icon-o-graphic control system is described within the specification and generally refers to a system wherein icons represent peripheral devices or tools that control the peripheral devices or their display, including videoconferencing and file sharing for example, video, audio, or image files. Examples of such icons can be found in the tables and are identified as such.

Means for contacting corresponding telemedicine systems, such as IP addresses or phone numbers, may optionally be saved in the system and accessed by a user. The system also optionally has the capability of providing a directory of users or searching for corresponding systems via the internet. Once a corresponding telemedicine system is identified, a user may interface with the corresponding system and user via for example video conferencing.

In some embodiments, when a telemedicine system is interfacing with a remote telemedicine system, the remote system can remotely control what peripheral devices are being displayed. The remote system displays the active icons of the home system and can interact with the icons as if he or she was using the home system. In certain embodiments, the control software allows a remote user (specialist) to take over the telemedicine system of referent doctor examining a patient in order to communicate audio and video signals or use/focus cameras. The multiple screens allow for video conferencing while simultaneously viewing data from a peripheral device.

### BRIEF DESCRIPTION OF THE DRAWINGS

FIG. 1 shows the bidirectional communication, via RS-232 and Ethernet interfaces, between the computer with control software, the videoconference CODEC, the audio/video matrix switch, and the peripheral biomedical devices.

FIG. 2 shows audio connections between the different devices that constitute the telemedicine system.

FIG. 3 shows video connections between the different devices that constitute the telemedicine system.

FIG. 4 shows a full diagram of the telemedicine system, which includes all connections and communications of the devices that constitute the system.

FIG. 5 shows an example of an icon-o-graphic interface on a video display provided by the control software of this invention before a session with a patient begins.

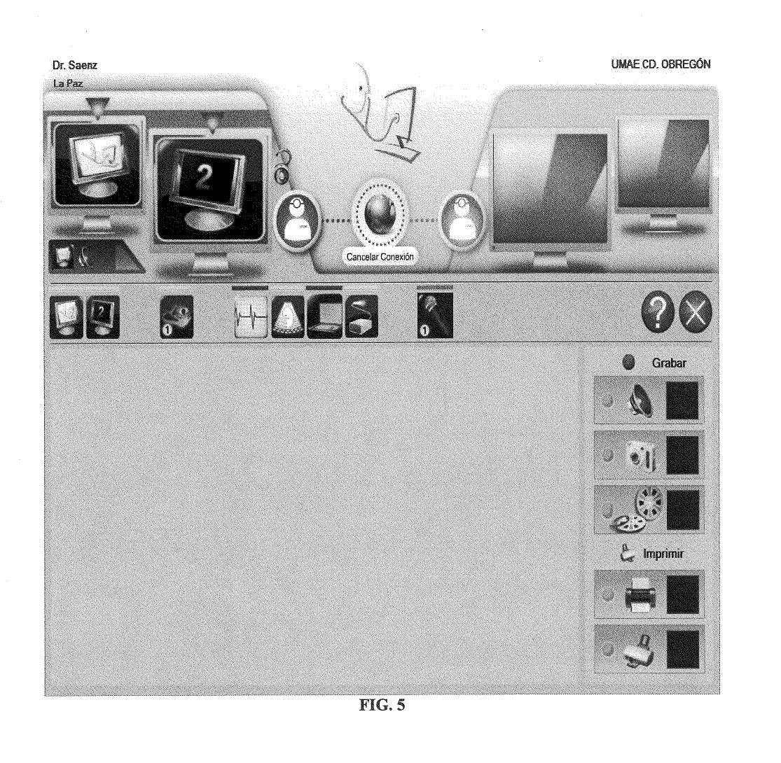

FIG. 6 shows an example of another icon-o-graphic interface on a video display provided by the control software of this invention during a session with a patient.

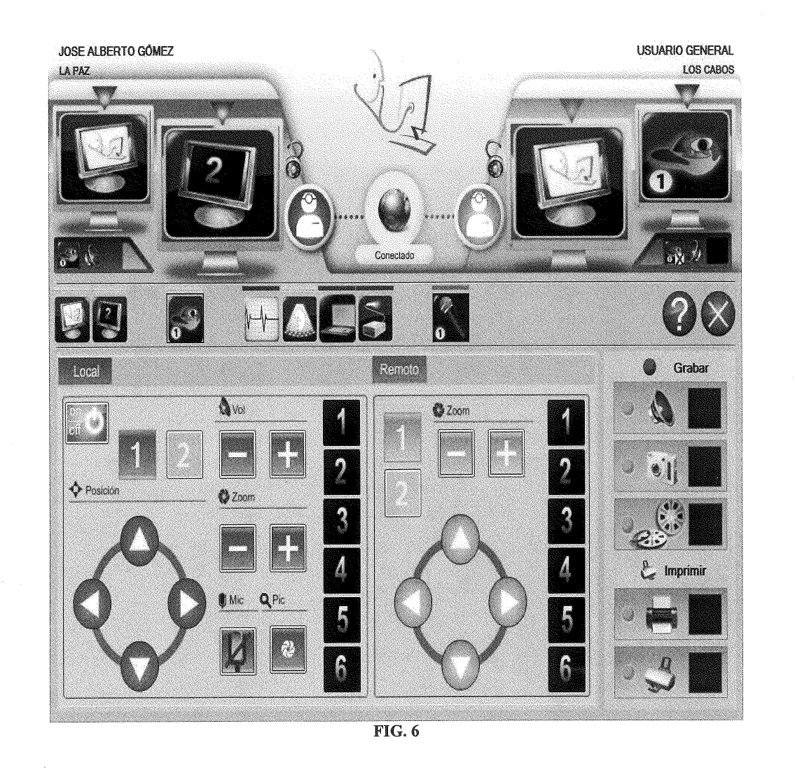

FIG. 7 is a table which provides examples of some of the control panel local folder tab icons.

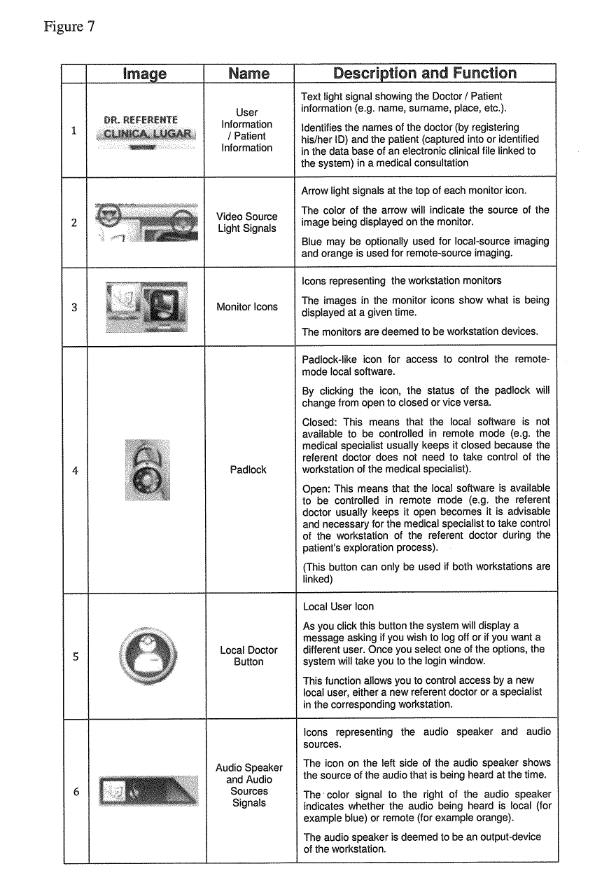

FIG. 8 is a table which provides examples of some input-device bar icons.

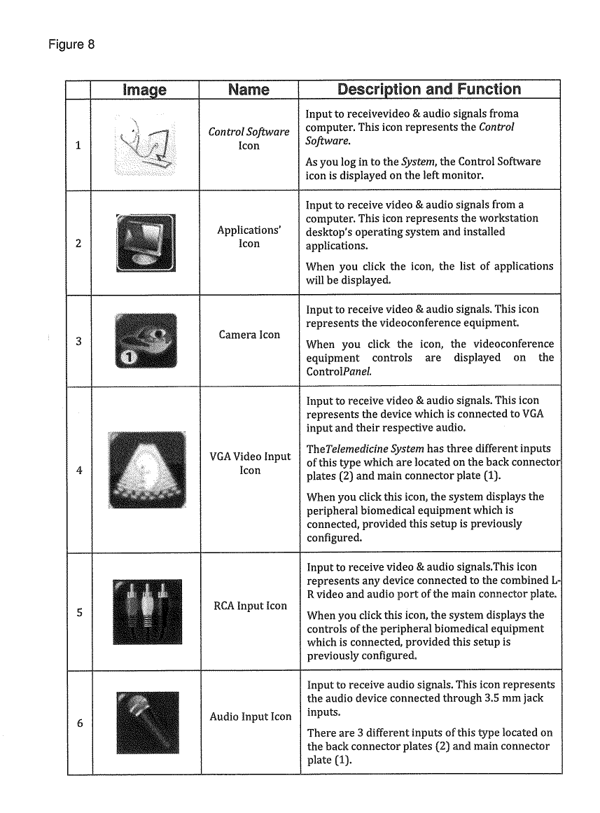

FIG. 9 is a table which provides examples of some optional camera control buttons.

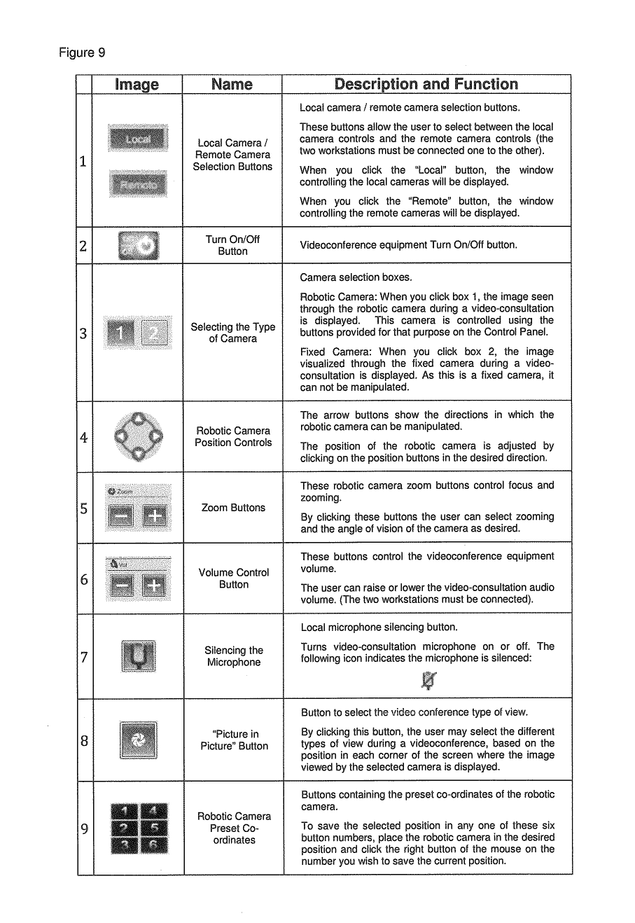

FIG. 10 is a table which provides examples of audio and video control tool icons.

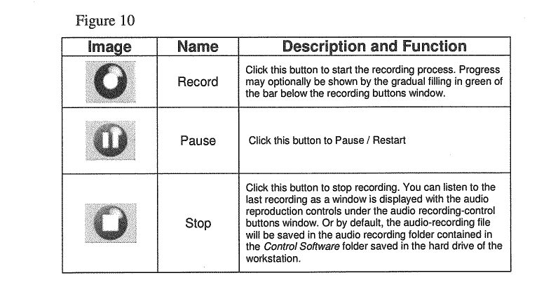

### DETAILED DESCRIPTION OF THE DRAWINGS

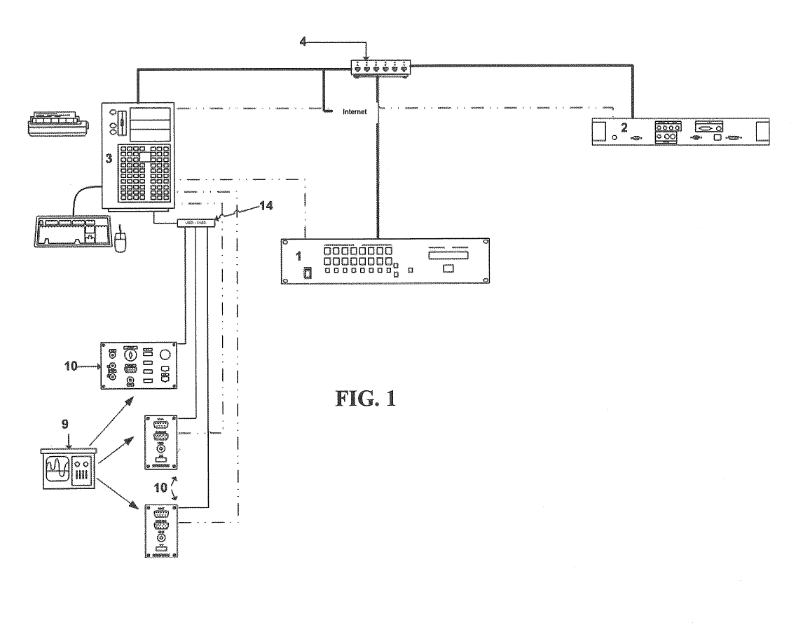

Referencing FIGS. 1-4 mentioned above, the telemedicine system has three main devices: audio/video matrix switch (1), videoconference CODEC (2) preferably compatible with ITU-T, H.323, H.320 and SIP standards, and the computer with control software (3). These three devices are capable of communicating in a bidirectional way, preferably through RS-232 and/or Ethernet interfaces, as shown in FIG. 1, and Ethernet switch (4) that is connected to the three devices and to Internet. The computer with control software (3) is attached to or otherwise in communication with the videoconference CODEC (2) and to the audio/video matrix switch (1) through RS-232 interface. This way, through these interfaces, the computer with control software (3) can send the instructions to the devices so that these execute different tasks. Peripheral biomedical devices (9) that generate data are directly connected to the computer with control software, preferably through the external RS-232 inputs (10) contained in the system; likewise, data interchange can be done through Ethernet interface, and it is also possible to control the equipment from the computer through the iconographic control software (3). The system preferably has a multi-USB (14) tool so that the external inputs (10) of the system can have several USB ports to enable multiple peripheral biomedical devices (9) as well as any other peripheral device to be attached to (electronically connected) with the computer with control software when required. This telemedicine system has external inputs (10) to which any peripheral device that possess a compound video, VGA, audio and data outputs can be connected.

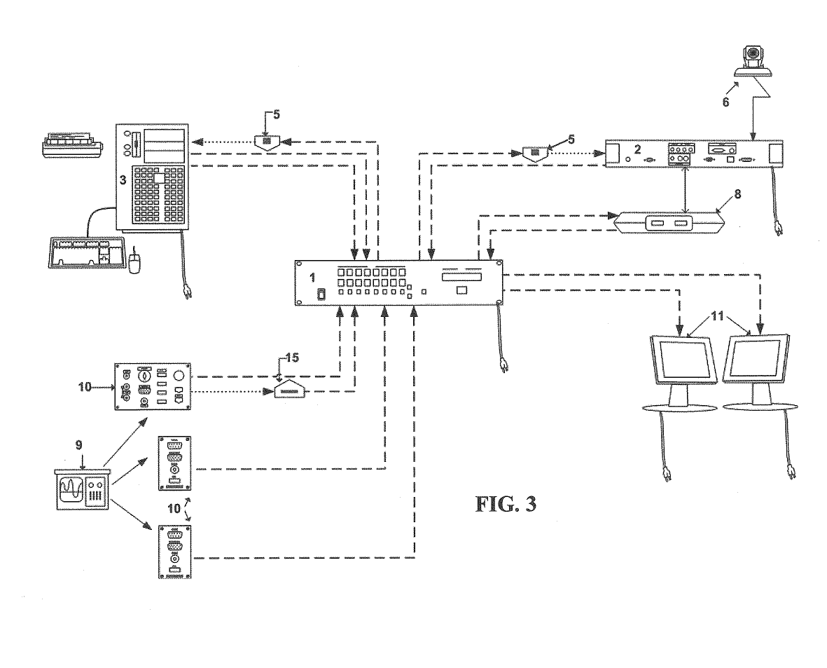

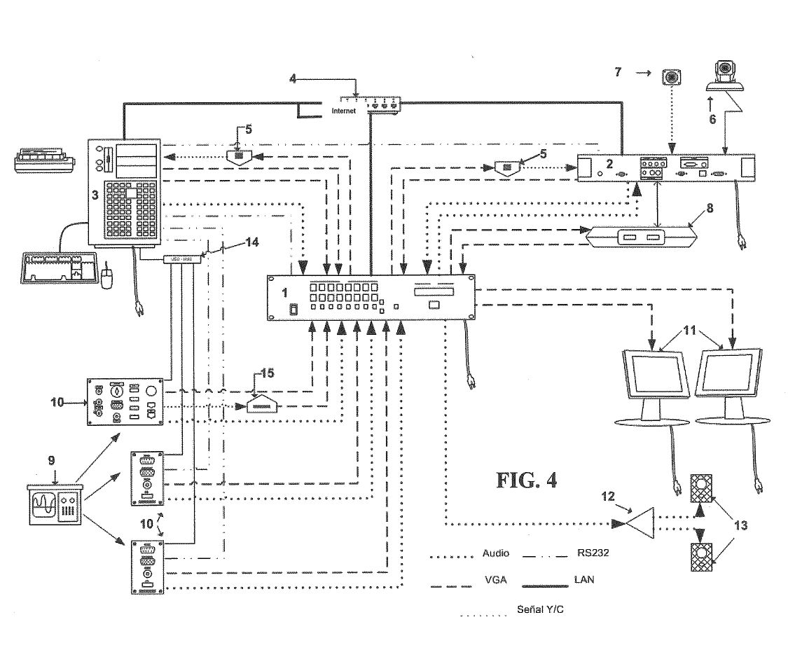

As shown in FIG. 3, a video signal, which can be NTSC or up to Full-High Definition Video, received from a remote location (6) is sent by the videoconference CODEC (2), in VGA format, directly to the audio/video matrix switch (1) to be commutated. The VGA signal received from the remote location is preferably also sent to a decoder/converter (8), which is a video decoder or a digital to analog converter, depending on the CODEC used, which transmits the VGA image to the audio/video matrix switch (1). The audio/video matrix switch (1) issues the signal, typically VGA or NTSC signals, received from any of the peripheral biomedical devices (9) and the computer (3) to the videoconference CODEC (2). If the signal issued by the peripheral biomedical device (9) is NTSC, it passes through a processor (15), FIG. 4, that converts it into VGA to be subsequently issued to the audio/video matrix switch (1), that is in charge of sending it to the VGA input port, video decoder (8), of the videoconference CODEC (2).

When the signal to be transmitted from the peripheral biomedical equipment (9) is required to be sent through a digital format video channel of a videoconference CODEC (2), the signal that comes from the audio/video matrix switch (1) can go through an analog digital converter (5) so that it can be received by the videoconference CODEC (2) and then transmitted to the remote location.

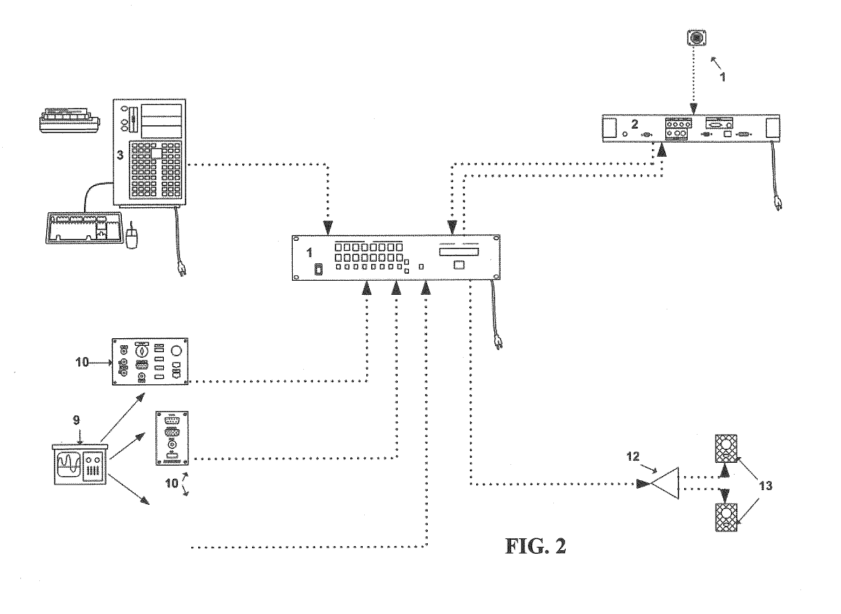

The audio/video matrix switch (1) is responsible for commutating the different audio and video signals of the various devices of the telemedicine system, as shown in FIGS. 2 and 3. The audio/video matrix switch (1) receives commands from the computer with control software (3) and reports its status in order to execute the required changes in the input and output ports.

The signals of the microphone (7) and the video camera (6) are directly issued to the videoconference CODEC (2) to transmit images and environmental audio. The audio and video output of the videoconference CODEC (2) is attached to or otherwise in communication with the audio/video matrix switch (1) standing by for the commands of the computer with control software (3) to transmit the audio and video of the system to another telemedicine system. In addition, it also receives audio and video from other telemedicine system with which it is communicated.

Audio and video from the computer (3) and from external audio/video inputs (10) of the peripheral biomedical devices (9) of the system are commutated by the audio/video matrix switch (1), according to the commands of the computer with control software (3), transmitting them to the local or remote system, or to both of them, depending on the action taken. Afterwards, different devices reproduce these signals. Audio signals are reproduced by an amplifier (12) and speakers (13); video signals, by monitors (11).

This invention allows the connection of different peripheral biomedical devices and it presents an interaction between the computer with iconographic control software, the videoconference CODEC, and the audio/video matrix switch, allowing the incorporation and control of the telemedicine system.

While FIGS. 1-4 represent the audio/video matrix switch (1), videoconference CODEC (2) and the computer with control software (3) as entities connected by external wires, the invention is not limited to this configuration.

Commercially available general use computers (e.g., PCs and Macintosh) are suitable for use in the telemedicine systems of this invention, such as those with an Intel Core i7 processor, as are specialty computers/servers used for video conferencing.

A suitable control software for use in the telemedicine systems of this invention is, PassiMed®, for which a copyright registration has been filed in Mexico (Number 03-2008-073110283800-01) and in the US on Mar. 10, 2011(Service Request/Reference No.: 1-388219061) by Medicina a Distancia, SA de CV of Mexico.

Open source software for telemedicine systems are known and include: Open Health Assistant; Sana; Borboleta; iPath and Xebra.

The use of Icons as a tool for making computer interfaces easier was developed in the 1970s and later popularized by the Apple and Microsoft Windows operating environments.

Examples of icon editors and computer icon software include: @icon sushi; Axialis IconWorkshop; IcoFX; IconBuilder; ICO Format; ImageMagick; Microangelo Toolset and Microangelo Creation.

A videoconference CODEC suitable for use in this invention is a device or software that enables video compression and decompression of digital video which include lossy and lossless video CODECs.

Examples of suitable Lossless compression Video CODECS include: Alpary, Animation, ArithYuv, AVIzlib, CamStudio GZIP, CorePNG, Dirac, FastCodec, FFV1, Huffyuv, Lagarith, LCL, LOCO, LZO, MSU Lossless Video Codec, PICVideo, SheerVideo, Snow, TSCC TechSmith Screen Capture Codec, x264, ZMBV (Zip Motion Block Video) Codec and YULS.

Examples of suitable lossy compression Video CODECS include: Audio Video Standard (AVS), Blackbird FORscene video codec, Cineform, Cinepak, Dirac, DV, Firebird, FFmpeg H.261 (libavcodec), MPEG-1 Part 2 (MPEG-1 Video), H.262/MPEG-2 Part 2 (MPEG-2 Video), FFmpeg H.263 (libavcodec), MPEG-4 Part 2 (MPEG-4 Advanced Simple Profile), H.264/MPEG-4 AVC or MPEG-4 Part 10 (MPEG-4 Advanced Video Coding), Indeo 3/4/5, MJPEG, JPEG 2000 intra frame video codec, OMS Video, On2 Technologies TrueMotion VP3/VP4, VP4, VP6, VP7, VP8, Pixlet, Apple ProRes 422, RealVideo, Snow Wavelet Codec, Sorenson Video, Sorenson Spark, Tarkin, Theora, FFmpeg, VC-1 (SMPTE standard, subset of Windows Media Video), VC-2 SMPTE standard, VC-3 SMPTE standard and Windows Media Video (WMV).

Examples of suitable software CODECs include MPEG-4 Part 2 codecs (DivX Pro Codec, Xvid, FFmpeg and 3ivx); H.264/MPEG-4 AVC codecs (x264, Nero Digital, QuickTime H.264 and DivX Pro Codec); Microsoft codecs(WMV and MS MPEG-4v3) and others (VP6, VP6-E, VP6-S, VP7, VP8 Schrödinger, dirac-research, DNxHD codec, Sorenson 3, Sorenson Spark, RealVideo, Cinepak and Indeo).

Preferred videoconferencing CODECs include those compatible with ITU, H.320, H323 and SIP standards.

Matrix switches suitable for the telemedicine system of his invention are known in the art. Preferred devices have the option to route audio and video and are known as A/V Matix switches. Suitable configurations can range from 2 inputs and 2 outputs to 32 inputs and 16 outputs. If larger configurations are needed, the matrix switches can be cascaded or daisy chained together. The matrix switches are classified by the video/audio signals they support. Suitable devices support the following signals Line

Level 1Vpp, AVI, WAV, DVI, DVI-D, SDI, HDMI, Component, RGB, S-Video, and c-Video. Preferred formats are Level 1Vpp, DVI-D, SDI, HDMI, Component, RGB, S-Video, and c-Video.

Suppliers of suitable matrix switches are: SYVIO Image Ltd, Hangzhou Hengsheng Electronic Technologies Co., Ltd, Shenzhen Ancend Electronic Technology Co., Ltd. and Ask Technology Co., Ltd.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of U.S. Provisional Application Ser. No. 61/329,778, filed Apr. 30, 2010, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

What is claimed is:

1. A telemedicine system comprising:
A. a computer with control software;
B. a videoconference CODEC in communication with said computer and controlled by said control software;
C. at least two inputs for peripheral biomedical devices to provide communication with said computer, and
D. an audio/video matrix switch in communication with said computer and controlled by said control software, wherein said audio/video matrix switch is capable of
1) controlling video/audio inputs and outputs,
2) transmitting audio signals to at least one speaker,
3) transmitting video signals to at least one video screen, and
4) integrating and controlling the communication of said peripheral biomedical devices with said computer.

2. A telemedicine system of claim 1 wherein
A. said control software is capable of providing an icon-o-graphic interface on a video screen;
B. said videoconference CODEC is compatible with ITU T H.320 H.323 and SIP standards;
C. peripheral biomedical devices are in communication with said computer through said inputs and are controlled by said control software; and
D. said audio/video matrix switch controls audio/video inputs and outputs through at least one of RS-232 or Ethernet interface.

3. A telemedicine system of claim 2 wherein said icon-o-graphic control software controls the display of audio/video inputs and outputs.

4. A telemedicine system of claim 3 wherein said icon-o-graphic control software allows the execution and configuration of software applications required by the peripheral biomedical devices to function.

5. A telemedicine system of claim 1 wherein peripheral biomedical devices are in communication with said computer and are an Electronic stethoscope, dermatoscope, X-Ray Scanner or electrocardiograph.

6. A telemedicine system comprising:
A. a portable frame for supporting electronic equipment;
B. electronic equipment, including a computer, for processing data and audio/video signals, supported by said portable frame;
C. at least two inputs for medical instruments for providing input (data, video and audio) to said electronic equipment,
D. medical instruments in communication with said electronic equipment through said inputs,
E. camera and microphone for providing audio/video input (signals) to said electronic equipment;
F. at least two video screens and at least one speaker for providing audio/video output from said electronic equipment; and
G. control software stored in said computer which can
display inputs from said medical instruments, microphone, and camera, in the form of descriptive icons,
share input data with at least one other corresponding telemedicine system in a different location, and
allow the user of the telemedicine system or the user of a corresponding telemedicine system to control the display of inputs from said medical instruments, microphone, and camera on multiple video screens through the manipulation of said descriptive icons.

7. A telemedicine system of claim 6 capable of transmitting and receiving medical instrument data and real-time or time delayed audio/video data to and from a corresponding telemedicine device.

8. A telemedicine system of claim 6 additionally comprising a mouse, a key board, a touch screen enabled video screen or a combination thereof which is capable of transmitting and providing user input to said electronic equipment by touching the video screens, using the mouse, using the keyboard or a combination thereof.

9. A telemedicine system of claim 6 wherein the control software provides:
i. movable descriptive icons representing each of the medical instruments inputs and the camera and microphone inputs from each telemedicine system;
ii. identifiable locations where moveable descriptive icons can be moved to on a video screen to activate audio/video output that corresponds to the input the icon represents; and
iii. non-movable icons that allow the user to control the audio/visual display.

10. A telemedicine system of claim 6 wherein the control software stores data from the medical instruments, camera, and microphone on a network or on the hard drive of the computer and associates the data with an icon that appears on the user interface screen.

11. A telemedicine system of claim 7 wherein up to four medical instruments can be connected to the telemedicine system.

12. A telemedicine system comprising:
A. a portable frame for supporting electronic equipment;
B. electronic equipment, including a computer, for processing data and audio/video signals, supported by said portable frame;
C. camera and microphone for providing audio/video input (signals) to said electronic equipment;
D. at least two video screens and at least one speaker for providing audio/video output from said electronic equipment;
E. and control software stored in said computer which can
display inputs from said medical instruments, microphone, and camera, in the form of descriptive icons,
share input data with at least one other corresponding telemedicine system in a different location, and
allow the user of the telemedicine system or the user of a telemedicine system to control the display of inputs from said medical instruments, microphone, and camera on multiple video screens through the manipulation of said descriptive icons.

13. A telemedicine system of claim 12 capable of receiving and displaying medical instrument data, microphone input data and camera audio/video input data from a corresponding telemedicine system in real time but only transmits microphone data and camera audio/video input data in real time or time delay to and from a corresponding telemedicine system.

14. A telemedicine system of claim 12 additionally comprising a mouse, a key board, a touch screen enabled video screen or a combination thereof which is capable of transmitting and providing user input to said electronic equipment by touching the video screens, using the mouse, using the keyboard or a combination thereof.

15. A telemedicine system of claim 12 wherein the control software provides:
i. movable descriptive icons representing each of the medical instruments inputs and the camera and microphone inputs from each telemedicine system;
ii. identifiable locations where moveable descriptive icons can be moved to on a video screen to activate audio/video output that corresponds to the input the icon represents; and
iii. non-movable icons that allow the user to control the audio/visual display.

16. The system of claim 12 which has 4 video display screens and is capable of displaying annotated video.

17. A telemedicine system of claim 12 wherein the software stores data from the medical instruments, camera, and microphone on a network or on the hard drive of the computer and associates the data with an icon that appears on the user interface screen.

18. A telemedicine system of claim 12 wherein up to four medical instruments can be in communication with the electrical equipment.

19. A network of telemedicine systems comprising:
A. at least one telemedicine system for integrating multiple medical instruments and capable of transmitting and receiving medical instrument data and real-time audio/video data to and from a corresponding telemedicine system comprising for example:
i. a portable frame for supporting electronic equipment;
ii. electronic equipment, including a computer, for processing data and audio/video signals, supported by said portable frame;
iii. at least two inputs for medical instruments for providing input (data, video and audio) to said electronic equipment;
iv. medical instruments in communication with said electronic equipment through said inputs,
v. camera and microphone for providing audio/video input (signals) to said electronic equipment;
vi. at least two video screens and at least one speaker for providing audio/video output from said electronic equipment; and
vii. control software stored in said computer which can
display inputs from said medical instruments, microphone, and camera, in the form of descriptive icons,
share input data with at least one other corresponding telemedicine system in a different location, and
allow the user of the telemedicine system or the user of a corresponding telemedicine system to control the display of inputs from said medical instruments, microphone, and camera on multiple video screens through the manipulation of said descriptive icons,
wherein the control software provides:
i. movable descriptive icons representing each of the medical instruments inputs and the camera and microphone inputs from each telemedicine system;
ii. identifiable locations where moveable descriptive icons can be moved to a video screen to activate audio/video output that corresponds to the input the icon represents; and
iii. non-movable icons that allow the user to control specific functions of each medical instrument and manipulate said medical instruments audio/visual display; and
B. at least one telemedicine system for receiving and displaying medical instruments, microphone, and camera audio/video input data from a corresponding telemedicine but only transmits microphone, and camera audio/video inputs in real time or time delayed comprising:
i. a portable frame for supporting electronic equipment;
ii. electronic equipment, including a computer for processing data and audio/video signals, supported by said portable frame;
iii. camera and microphone for providing audio/video input (signals) to said electronic equipment;
iv. at least two video screens and at least one speaker for providing audio/video output from said electronic equipment; and
v. control software stored in said computer which can
display inputs from said medical instruments, microphone, and camera, in the form of descriptive icons,
share input data with at least one other corresponding telemedicine system in a different location, and
allow the user of the telemedicine system or the user of a corresponding telemedicine system to control the display of inputs from said medical instruments, microphone, and camera on multiple video screens through the manipulation of said descriptive icons,
wherein the control software provides:
i. movable descriptive icons representing each of the medical instruments inputs and the camera and microphone inputs from each telemedicine system;
ii. identifiable locations where moveable descriptive icons can be moved to on a video screen to activate audio/video output that corresponds to the input the icon represents; and
iii. non-movable icons that allow the user to control specific functions of each medical instrument and manipulate said medical instruments audio/visual display.

20. A network of telemedicine systems of claim 19 which provides audio/video communication and information from medical instruments at a remote location in real time or time delayed.

21. A network of telemedicine systems of claim 19 additionally comprising a mouse, a key board, a touch screen enabled video screen or a combination thereof which is capable of transmitting and providing user input to said electronic equipment by touching the video screens, using the mouse, using the keyboard or a combination thereof.

22. A network of telemedicine systems of claim 19 wherein the software stores data from the medical instruments, camera, and microphone on a network or on the hard drive of the telemedicine system and associates the data with an icon that appears on the user interface screen of any telemedicine systems in the system and is accessed when the icon is moved to a location representing a video screen on the telemedicine system.

23. A network of telemedicine systems of claim 19 wherein accessing an icon associated with the camera and microphone displays the data from the camera and microphone in real time, but accessing and icon associated with a medical instrument displays the data from the medical instrument with a time delay.

24. A network of telemedicine systems of claim 19 wherein the input data displayed can be paused, fast forwarded, or rewound.

25. A network of telemedicine systems of claim 19 wherein said control software allows a remote user to take over the telemedicine system of a doctor examining a patient in order to communicate audio and video signals or use/focus cameras.

26. A network of telemedicine systems of claim 19, wherein the control software measures broadband traffic and reconfigures the speed of the video-consultation automatically.
